(19) United States
(12) Patent Application Publication
(10) Pub. No.: US 2022/0048105 A1
(43) Pub. Date: Feb. 17, 2022

(54) ACOUSTIC ROTARY LIQUID PROCESSOR

(71) Applicant: Qingyou Han, (US)

(72) Inventor: Qingyou Han, West Lafayette, IN (US)

(73) Assignee: Qingyou Han, West Lafayette, IN (US)

(21) Appl. No.: 16/992,256

(22) Filed: Aug. 13, 2020

(51) Int. Cl. B22D 27/08; B22D 1/00; B22D 27/00

(52) U.S. Cl. CPC B22D 27/08; B22D 17/007; B22D 27/006; B22D 1/002

(57) ABSTRACT

An acoustic rotary liquid processor coupled with high-intensity ultrasonic vibration, rotary stiffing, gas purging, and melt surface stabilizing is described. The processor can be used for the synthesis of particulate reinforced composite materials, scavenging dissolved gases in molten materials, and preparation of a slurry containing a small fraction of non-dendritic solid particles for semi-solid material processing.

### GRANT STATEMENT

None.

### FIELD OF THE INVENTION

The present invention relates to the processing of liquid materials, more specifically, to a novel method and an apparatus for acoustic assisted rotary stiffing of liquid materials for making solid articles.

### BACKGROUND OF THE INVENTION

Liquid processing is usually the first step of fabricating solid articles from a liquid material. Solid charging materials heated to above the melting temperature of their corresponding mean composition eventually become a liquid. The liquid has to be processed before casting. Liquid processing in this invention includes but is not limited to removing dissolved gases in the liquid, and forming a slurry containing a dispersion of small particles such as nano-particles or non-dendritic primary phase particles that precipitate from the liquid at temperatures below the liquidus of the material.

Formation and dispersion of small particles in a liquid can be achieved by introducing a gas or a mixture of gases into the liquid material, and providing conditions to encourage the chemical reactions between the liquid material and the gases to form solid particles. U.S. Pat. No. 6,434,640 to Reddy at al. discloses a method of forming metal/refractory composites by bubbling a reactive gas through a melt. The melt has to be held at extremely high temperatures for the gas-melt reactions to be substantial. Zheng et al. have studied the formation of AlN in Al melt using nitrogen gas and found that the melt had to be held at 1173-1573 K [1-2]. Yang et al. report experimental results on AlN particulate reinforced AZ91D magnesium alloy. AlN nano-particles were obtained by bubbling nitrogen gas through the molten AZ91D alloy at 1023 K for 70 min. [3]. Compared to the matrix AZ91D alloy, the AlN particulate reinforced AZ91D has a greater than 30% increase in tensile strength and 400% increase in its elongation to fracture. It is evident that the process is promising for enhancing the mechanical properties of lightweight materials but the processing temperatures are too high and the processing duration is too long. Gas absorption in molten metal and oxidation of the molten metal are the issues at such high temperatures. There is a need to develop technologies that are capable of reducing the synthesizing temperatures and duration of these materials.

High-intensity ultrasonic vibration has been proven to be effective in lowering the reaction temperatures in molten material. The irradiation of high intensity ultrasonic energy into molten metal brings about cavitation: the formation, growth, and implosive collapse of bubbles in a liquid, which produces transient micro “hot spots” that can have temperatures about 5000° C., pressure about 1000 atm., and heating/cooling rates above 10¹⁰°K/s [4]. The collapse of the bubbles also produces extensive shock that causes high speed collisions of particles suspended in the liquid [4] and induce nucleation of solid crystals [5]. These sonochemical phenomena ought to affect the chemical reactions between the gases and the molten metal, reducing the processing temperatures and duration of the AlN particulate reinforced metal matrix composites.

U.S. Pat. No. 9,222,158 to Han et al. discloses a method of using high-intensity ultrasonic vibration for producing particulate-reinforced composites. Acoustic energy is radiated to molten aluminum containing titanium particles to reduce the reaction temperatures and to break up Al₃Ti particles that are formed in the chemical reaction of aluminum and titanium [6]. The method has to be modified for processing molten materials injected with gas bubbles or with a purging gas containing solid particles.

U.S. Pat. No. 7,682,556 to Han et al., and U.S. Pat. No. 8,574,336 to Rundquist et al., disclose a method of ultrasonic degassing by introducing inert gases through a sonotrode into molten metal to remove hydrogen. It is effective in braking up inert gas bubbles that are released from the tip of a sonotrode into small bubbles. This method could be useful to encourage gas/melt chemical reactions in forming MN particles. However, the distribution of the inert gas bubbles in the melt is not so uniform, leading to a low efficacy in degassing molten metal. There is a need to improve this method for increased efficacy of degassing and chemical reactions. Combining acoustic degassing with stiffing could be more effective in degassing, but vortex formation in the melt is still a problem.

Stirring has been proven effective in enhancing chemical reactions and degassing in the melt. Several methods have been proposed for degassing molten metal alloys. For example, U.S. Pat. No. 6,887,424 to Ohno et al. describes a process for inline degassing of molten metals using a rotary device for generating bubbles of inert gas in the molten metal. U.S. Pat. No. 5,660,614 to Waite et al. and U.S. Pat. No. 5,340,379 to Tremblay et al. describe devices for injecting gas into molten aluminum. However, in these devices, degassing is a relatively slow process due to the large size of the bubbles that are produced.

Stiffing has also been used for forming spherical solid phase grains from the liquid when it cools down to its liquidus temperature. U.S. Pat. No. 6,545,323 to Flemings et al. and U.S. Pat. No. 6,918,427 to Yurko et al. disclose the use of a rotating rod/agitator for cooling and stiffing the aluminum melt to induce nucleation and growth of spherical grains for semi-solid processing. However, stiffing using a rotating rod/agitator is bound to produce a large vortex in the melt which causes entrapment of gases and formation of oxides.

Therefore, there is a need for developing a novel liquid processor that is capable of effectively processing particulate-reinforced metal matrix composites, removing gas impurities in the molten materials, and forming a slurry containing a small fraction of spherical primary phase particles for semi-solid processing.

### SUMMARY OF THE INVENTION

In an exemplary embodiment of the present invention, a process of synthesis of particulate-reinforced metal matrix composites from a liquid material is provided. The process includes the steps of preparing a melt, submerging a plurality of sonotrode and a rotor, or a sonotrode rotor, into the melt, using a baffle plate submerged into the melt to prevent vortex formation, introducing a gas or a mixture of gases and solid particles either through the sonotrode or the rotor into the melt, and stiffing the melt containing the introduced materials with the rotor and the radiation of high-intensity ultrasonic vibration until particles are formed and are uniformly distributed in the melt.

In another exemplary embodiment of the present invention, a process is provided for reducing the processing temperature of particulate-reinforced metal matrix composites from a liquid material. The process includes the steps of preparing a melt, submerging a plurality of sonotrode and a rotor, or a sonotrode rotor, into the melt, using a baffle plate submerged into the melt to prevent vortex formation, introducing a gas or a mixture of gases and solid particles either through the sonotrode or the rotor into the melt, and stiffing the melt containing the introduced materials with the rotor and the radiation of high-intensity ultrasonic vibration until particles are formed and are uniformly distributed in the melt.

In yet another exemplary embodiment of the present invention, a process is provided for the scavenging gas treatment of melts. The process includes the steps of preparing a melt, submerging a plurality of sonotrode and a rotor, or a sonotrode rotor, into the melt, using a baffle plate submerged into the melt to prevent vortex formation, introducing a gas or a mixture of gases and solid particles either through the sonotrode or the rotor into the melt, and stiffing the melt containing the introduced materials with the rotor and the radiation of high-intensity ultrasonic vibration until dissolved gases in the melt are removed to a desired level.

In yet another exemplary embodiment of the present invention, a process is provided for producing slurry containing a small fraction of spherical solid particles. The process includes the steps of preparing a melt, submerging a plurality of sonotrode and a rotor, or a sonotrode rotor, into the melt, using a baffle plate submerged into the melt to prevent vortex formation, and stiffing the melt containing the introduced materials with the rotor and the radiation of high-intensity ultrasonic energy until a desired fraction of spherical solid particles is formed in the melt.

In still another exemplary embodiment, an apparatus of acoustic rotary liquid processor is provided. The apparatus includes an ultrasonic system having at least one sonotrode for providing irradiation of high-intensity ultrasonic energy into the melt, a rotary system containing at least one rotor, or one sonotrode rotor, for dispersing bubbles in the melt, a baffle plate to prevent vortex formation in the melt, and a gas delivery system for providing gases or a mixture of gas and solid particle through either the sonotrodes or the rotor into the melt. The sonotrode has at least one through hole that defines the flow path for transporting a purge gas to the molten material. The frequency of ultrasonic vibration is in the range of about 15,000 Hz to 1,000,000 Hz. The intensity of the ultrasonic vibration should be high enough to create cavitations in the melt near the sonotrode. The cavitation threshold is about 1 MPa in the molten aluminum and cavitation is fully developed at 10 MPa. Under full cavitation conditions, gas bubbles released at the tip of the sonotrode are expected to be broken into smaller bubbles. These smaller bubbles are more effective in reacting with the molten materials or in scavenging dissolved gases in the molten metal. The gas flow rate is dependent on the use of this apparatus, up to 201/min The rotor, rotating up to 1000 rpm, further breaks up bubbles, disperses them uniformly, and extends their stay duration in the melt which is beneficial for enhancing gas/melt reaction and degassing.

### BRIEF DESCRIPTION OF THE DRAWINGS

FIG. 1 is a schematic representation of an acoustic rotary liquid processor using a sonotrode rotor and a baffle plate in accordance with this invention.

FIG. 2 is a schematic representation of an acoustic rotary liquid processor using a rotor, a baffle plate, and an acoustic vibrator in accordance with this invention.

FIG. 3 is another schematic representation of an acoustic rotary liquid processor using a rotor, a baffle plate, and an acoustic vibrator in accordance with this invention.

FIG. 4 is another schematic representation of an acoustic rotary liquid processor using a sonotrode rotor and a baffle plate in accordance with this invention.

### DETAILED DESCRIPTION OF THE INVENTION

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

The present invention teaches to combine the beneficial effects of high-intensity ultrasonic vibration and rotary stiffing on liquid material processing in a unique way to generate cavitations, create bubbles or solid phase particles, break up bubbles and solid particles, and disperse them in the melt. The injection of high-intensity ultrasonic vibration produces transient micro “hot spots” that can have temperatures about 5000° C., pressures about 1000 atm, and heating/cooling rates above 10¹⁰°K/s [4]. Such micro “hot spots” can be used for decreasing the processing temperatures in the bulk melt for particulate reinforced metal matrix composites formed using the gas/melt reaction route [3]. The micro “hot spots” and resultant shock waves are also extremely effective in breaking up bubbles into small ones and solids into smaller fragments. However, cavitations can only be generated in the melt close to the sonotrode due to the attenuation of ultrasonic vibration. Acoustic streaming is also limited to a close vicinity to the sonotrode. Introducing gases through the center of a sonotrode to the melt is an effective way of breaking up the gas bubbles as they are released from the sonotrode to the melt [6-7]. Small bubbles are more effective than larger ones in enhancing degassing and chemical reactions in the melt [4-9]. Rotational stiffing is an effective means of dispersing bubbles and particles in the melt. The stiffing can also transport bubbles and particles to the vicinity of the sonotrodes so that they can be processed using ultrasonic energy. However, stiffing creates a large vortex which has to be suppressed. The use of a baffle plate is effective in suppressing vortex from formation.

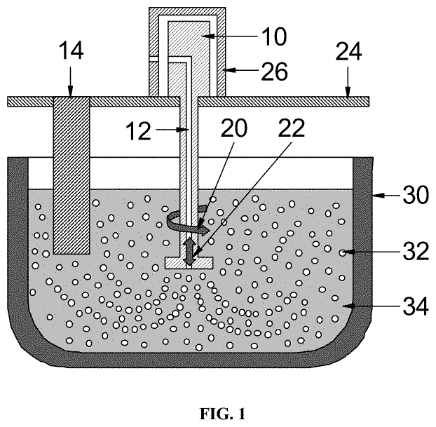

FIG. 1 illustrates a method and an apparatus according to one embodiment of the present invention. Molten material 34 is transported to a crucible 30. A rotary ultrasonic vibrator 10 fixed on a rigid structure 24 is used for processing the melt 34. The rotary ultrasonic vibrator 10 rotates in an exemplary direction 20 and vibrates in an exemplary direction 22. A purging gas (not shown in FIG. 1) is provided to a housing 26 and is transported in a pathway 12 through the sonotrode of the rotary ultrasonic vibrator 10 to the melt 34. Upon release from the exit of the sonotrode of the rotary ultrasonic vibrator 10, the gas stream is broken up into small bubbles 32. The rotary ultrasonic vibrator 10 is also used to disperse these small bubbles 32 uniformly in the melt 34. The baffle plate 14, which is also fixed on the rigid structure 24, prevents vortex formation in the melt 34 caused by the rotational stiffing. The rigid structure 24, used for hosting the baffle plate 14, the housing 26, and the rotary ultrasonic vibrator 10, can also be used for sealing the melt 34 using known technologies so that a protective atmosphere can be formed on top of the melt 34. The purging gas can be a single gas, a mixture of gases, or a mixture of gases and solid particles. To increase the effectiveness of processing a liquid material, the baffle plate 14 shown in FIG. 1 can be coupled with high-intensity ultrasonic vibration as well. The acoustically activated baffle plate 14 not only enhances the creation of micro “hot shots” and shock waves but also helps shake off liquid material that may attach to the surface of the plate as it is removed from the melt 34.

The apparatus shown in FIG. 1 can find a few applications which include but are not limited to 1) forming particulate reinforced composites if a reactive mixture of gases is introduced in the melt, 2) dispersing small particles from their clusters into a melt if the small particles are purged into the melt using a carrying gas, 3) scavenging unwanted dissolved gases in the melt if an inert gas is introduced into the melt, and 4) forming a slurry of a liquid containing a small fraction of solid particles that precipice from the melt when the melt is cooled to temperatures slightly below its liquidus temperature.

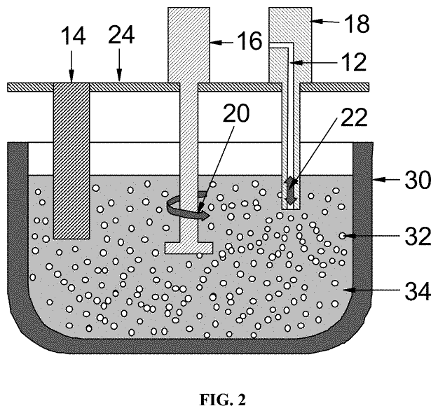

FIG. 2 illustrates another version of an apparatus shown in FIG. 1 according to one embodiment of the present invention. An ultrasonic vibrator 18 is used for breaking up bubbles 32 and particles, and creating micro “hot spots” in the melt 34. A rotor 16 is used for dispersing bubbles 32 and particles uniformly in the melt 34. A baffle plate 14 is used for preventing vortex formation in the melt 34. The rigid structure 24, used for hosting the baffle plate 14, the housing 26, and the vibrator 18, can also be used for sealing the melt 34 using known technologies so that a protective atmosphere can be formed on top of the melt 34. The purging gas can be a single gas, a mixture of gases, or a mixture of gases and solid particles. To increase the effectiveness of processing a liquid material, the baffle plate 14 shown in FIG. 2 can be coupled with high-intensity ultrasonic vibration as well. The acoustically activated baffle plate 14 not only enhances the creation of micro “hot shots” and shock waves but also helps shake off liquid material that may attach to the surface of the plate as it is removed from the melt 34. The apparatus shown in FIG. 2 can find a few applications which include but are not limited to 1) forming particulate reinforced composites if a reactive mixture of gases is introduced in the melt, 2) dispersing small particles from their clusters into a melt if the small particles are purged into the melt using a carrying gas, 3) scavenging unwanted dissolved gases in the melt if an inert gas is introduced into the melt, and 4) forming a slurry of a liquid containing a small fraction of solid particles that precipice from the melt when the melt is cooled to temperatures slightly below its liquidus temperature.

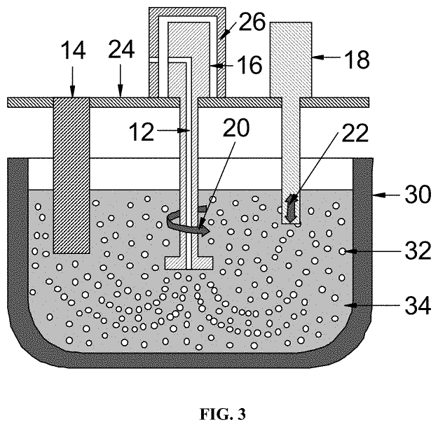

FIG. 3 illustrates another version of an apparatus shown in FIG. 1 according to one embodiment of the present invention. The rotor 16 has a through hole 12 for the delivery a purging gas to the melt 34. Ultrasonic vibrators 18 are used for injecting high-intensity ultrasonic energy into the melt 34. The baffle plate 14, used for suppressing vortex formation in the melt 34, can also be coupled with high-intensity ultrasonic vibration. The apparatus shown in FIG. 3 is capable of performing the functions described in the apparatus shown in FIGS. 1 and 2.

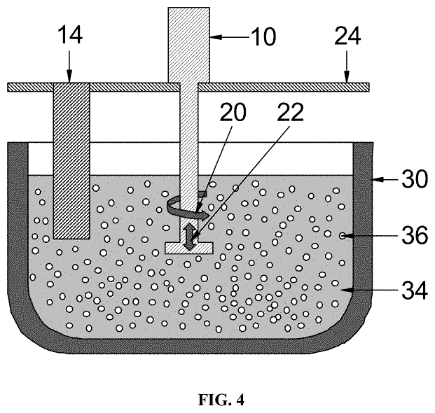

FIG. 4 illustrates another version of the apparatus shown in FIG. 1 according to one embodiment of the present invention for preparing a slurry containing a small fraction of solid particles that precipitate from the melt on cooling. Different from the apparatus shown in FIG. 1, no purging gas is needed for the preparation of the slurry. The rotary ultrasonic vibrator 10 stirs the melt 34 as it is cooled to temperatures slightly below its liquidus temperature. Dendrites precipitated from the melt 34 are broken up into spherical fragments 36. A baffle plate 14 is used to prevent vortex formation so that the apparatus shown in FIG. 4 can be used to process a melt 34 held in a small crucible or a small ladle 30. The rigid structure 24 is used for submerging the rotary ultrasonic vibrator 10 and the baffle plate 14 into the melt 34 and removing them out of the melt 34 after the slurry is prepared. The slurry can then be cast to form solid articles.

The invention further provides examples of using an acoustic rotary liquid processor the synthesis of particulate reinforced composite materials, scavenging dissolved gases in molten materials, and preparation of a slurry containing a small fraction of non-dendritic solid particles for semi-solid material processing. The examples provided below are meant merely to exemplify several embodiments, and should not be interpreted as limiting the scope of the claims, which are delimited only by the specification.

### Example 1

In a prior art [3], in-situ synthesis of AlN/AZ91D matrix composites was processed using the gas/melt reaction route. 1 kg AZ91D alloy was melted under an argon atmosphere and held at 1023 K in a stainless crucible. A dry nitrogen gas was introduced at the bottom of the melt using a stainless tube at a rate of 200 ml/min for 70 min while the melt was still maintained at 1023 K. The melt was then cast into metal molds for making rod specimens of 12 mm in diameter. Microstructural characterization indicates that AlN particles smaller than 1 micrometer (μm) were formed in the samples [3]. Compared to the matrix AZ91D alloy, the AlN nano-particulate reinforced AZ91D has a greater than 30% increase in tensile strength and 400% in increase in its elongation to fracture. The AlN reinforced magnesium AZ91D alloy is the toughest AZ91D alloy ever made. Magnesium alloys have been widely used in the aviation and automotive industry as lightweight materials. Using the present invention shown in FIGS. 1-3, the dry nitrogen gas can be introduced to the AZ91D melt through the tip of a sonotrode. The nitrogen bubbles thus produced using the present invention should be much smaller, and their reaction to aluminum in the melt should be much faster than those created using the prior art [3].

### Example 2

In a prior art, the degassing of molten aluminum is performed using rotary degassing. The process purges a mixture of an inert gas with a small percentage of chlorine into molten aluminum for scavenging dissolved hydrogen in the melt. Chlorine is used for dissolving the oxide film formed on the bubble surfaces and to accelerate degassing. Ultrasonic degassing is capable of degassing without using chlorine. Results on ultrasonic degassing of AA 5xxx alloys are reported in the literature [10] using a 4-head Ultra-D degassing system described in the U.S. Pat. No. 8,574,336 to Rundquist et al. The initial hydrogen level in the molten aluminum alloys was in the range of between 0.2 to 0.5 mL/100 g. The 4-head Ultra-D system was able to degas hydrogen in molten aluminum alloy to the level of between 0.11 to 0.13 mL/100 g at production rates of between 8,000 to 12,000 pounds of aluminum per hour. It is expected that the use of the present invention as shown in FIGS. 1-3 should reduce the use of inert gases and increase the efficiency of ultrasonic degassing without using chlorine gas.

### Example 3

In prior arts, slurry containing a small fraction of non-dendritic particles is made using a rotating probe/rod in a crucible. U.S. Pat. No. 6,645,323 to Flemings et al. discloses the use of a cool rotating probe to agitate a liquid material close to its liquidus temperature for obtaining the slurry containing a small fraction of non-dendritic solid fragments suitable for semi-solid processing. A problem with the process is that the cool rotating probe/rod tends to become coated with a liquid material that sticks to the surfaces of the agitator. U.S. Pat. No. 6,918,427 to Yurko et al. describes a technology using a graphite probe/rod for agitating the liquid to obtain the semi-solid material because certain liquid materials do not stick much on graphite. The present invention shown in FIGS. 1-4 is capable of processing semi-solid material as well, especially the approach shown in FIG. 4. Stirring using a rotary ultrasonic vibrator is more severe than that using a rotating rod. The use of a baffle plate makes stiffing more severe but the surface of the melt smoother than using a rotating rod. The radiation of high-intensity ultrasonic energy into the melt enhances the stiffing and breaking up of dendrites. In addition, ultrasonic vibration causes acoustic streaming in at the interfaces between solid object and the melt which shakes off liquid that may stick on the surfaces of the baffle plate and the acoustic rotary ultrasonic vibrator.

While the invention has been described in connection with specific embodiments thereof, it will be understood that the inventive methodology is capable of further modifications. This patent application is intended to cover any variations, uses, or adaptations of the invention following, in general, the principles of the invention and including such departures from the present disclosure as come within known or customary practice within the art to which the invention pertains and as may be applied to the essential features herein before set forth and as follows in scope of the appended claims.

### REFERENCES

1. Q. Zheng, R. G. Reddy, “Mechanism of in situ Formation of MN in Al Melt Using Nitrogen Gas,” Journal of Materials Science, vol. 39, 2004, pp. 141-149.

### 2. Q. Zheng, B. Wu, and R. G. Reddy, “In-Situ Processing of Al Alloy Composites,” Advanced Engineering Materials, vol. 3, 2003, pp. 167-172.

3. C. Yang, B. Zhang, D. Zhao, X. Li, T. Zhai, Q. Han, and F. Liu, “In-Situ Synthesis of AlN/Mg—Al Composites with High Strength and High Plasticity,” Journal of Alloys and Composites, vol. 699, 2017, pp. 627-632.

### 4. S. Suslick, “Sonochemistry,” Science, vol. 247, 1990, pp. 1439-1445.

### 5. M. Rakita, Q. Han, “Influence of Pressure Field in Melts on the Primary Nucleation in Solidification Processing,” Metallurgical and Materials Transaction B, vol. 48, 2017, pp. 2232-2244.

### 6. Q. Han, “Ultrasonic Processing of Materials,” Metallurgical and Materials Transaction B, vol. 46, 2015, pp. 3975-3979.

### 7. H. Xu, Q. Han, and T. T. Meek, “Effects of Ultrasonic Vibration on Degassing of Aluminum Alloys,” Materials Science and Engineering A, vol. 473, 2008, pp. 96-104.

### 8. H. Xu, X. Jian, T. T. Meek, and Q. Han, “Degassing of Molten Aluminum A356 Alloy Using Ultrasonic Vibration,” Materials Letters, vol. 58, 2004, pp.3669-3673.

### 9. H. Xu, T. T. Meek, and Q. Han, “Effects of Ultrasonic Field and Vacuum on Degassing of Molten Aluminum Alloy,” Materials Letters, vol. 61, 2007, pp. 1246-1250.

### 10. V. Runsquist, K. Manchiraju, and Q. Han, “Ultrasonic Degassing and Processing of Aluminum Part II,” Light Metals 2015, 2015, pp. 943-948.

What is claimed is:

1. A method of processing a freezable liquid material for at least an improved synthesis of particulate reinforced metal matrix composite, degassing of molten metal, or preparation of a semi-solid slurry, the method comprising of:
using an elongated baffle plate partially submerged into the bath of liquid material to prevent vortex formation wherein the elongated baffle plate may or may not be coupled with high-intensity ultrasonic vibrations;
operating an ultrasonic rotary device to stir the bath of liquid material, the device comprising of:
a rotation driver,
a plurality of at least one ultrasonic transducer,
a plurality of at least one elongated sonotrode or elongated sonotrode rotor comprising a first end and a second end, the first end attached to the ultrasonic transducer and the second end comprising a tip,
an elongated rotor or an elongated sonotrode rotor, and
a purging gas delivery system, embedded either in one elongated sonotrode, elongated rotor, or elongated sonotrode rotor comprising of a purging gas pathway and a purging gas outlet which is at the tip of the corresponding second end of the elongated article; and
introducing a purging gas into the bath of liquid material through the said purging gas outlet.

2. The method of claim 1, wherein the said liquid material comprises of but is not limited to aluminum, copper, magnesium, iron, silicon, zinc, their alloy, or a combination thereof.

3. The method of claim 1, wherein the liquid material is an aluminum alloy at temperatures above its liquidus temperature.

4. The method of claim 1, wherein the purging gas comprises of a single gas, a mixture of gases, or a mixture of gases containing certain fractions of solid particles that are conventionally used for the purpose of the liquid processing such as the degassing of molten metal and the in-situ fabrication of particulate reinforced composites.

5. The method of claim 2, wherein the purging gas is introduced into the liquid bath at a rate in a range between about 0 to about 300 L/min.

6. The method of claim 1, wherein the rotor of the ultrasonic rotary device rotates at a rate in a range between about 60 rounds per min. to about 2,000 rounds per min.

7. The method of claim 1, wherein the ultrasonic system operates at a frequency in a range between 15,000 Hz to 400,000 Hz with the intensity of vibration high enough to generate cavitations in the liquid bath adjacent to the tip of the second end of the sonotrode.

8. The method of claim 1, wherein the materials of the component submerged into the bath of liquid material are conventionally known to be resistant to the attack of molten bath under the processing conditions, such as graphite, steels, refractory metals and their alloys, and ceramic materials.

9. The method of claim 1, wherein the said sonotrode or the said sonotrode rotor is made of steel, titanium alloy, niobium alloy, or ceramic materials such as sialon.

10. The method of claim 1, wherein the second tip of the elongated sonotrode article is made of material similar or dissimilar to the main body of the elongated sonotrode article.

11. A method of processing a molten metallic material for preparing of semi-solid slurry, the method comprising of:
using an elongated baffle plate partially submerged into the liquid bath to prevent vortex formation wherein the elongated baffle plate may or may not be coupled with high-intensity ultrasonic vibration;
operating an ultrasonic rotary device to stir the liquid bath, the device comprising of:
a rotation driver,
an elongated rotor or an elongated sonotrode rotor,
a plurality of at least one ultrasonic transducer, and
a plurality of at least one elongated sonotrode comprising of a first end and a second end with the first end attached to the ultrasonic transducer and the second end comprising a rotor shaped tip; and
submerging the said elongated articles into the melt bah for a predetermined duration and removed the elongated articles out of the bath after the slurry containing a predetermined fraction of non-dendritic solid has been obtained.

12. The method of claim 11, wherein the said liquid material comprises of but is not limited to aluminum, copper, magnesium, iron, silicon, zinc, their alloy, or a combination thereof.

13. The method of claim 11, wherein the liquid material is an aluminum alloy at temperatures above its liquidus temperature.

14. The method of claim 11, wherein the ultrasonic system operates at a frequency in a range between 15,000 Hz to 400,000 Hz with the intensity of vibration high enough to generate cavitations in the liquid bath adjacent to the tip of the second end of the sonotrode.

15. The method of claim 11, wherein the materials of the component submerged into the bath of liquid material are conventionally known to be resistant to the attack of molten bath under the processing conditions, such as graphite, steels, refractory metals and their alloys, and ceramic materials.

16. The method of claim 11, wherein the said sonotrode or the said sonotrode rotor is made of steel, titanium alloy, niobium alloy, or refractory metallic alloy.

17. The method of claim 11, wherein the second tip of the elongated sonotrode article is made of material similar or dissimilar to the main body of the elongated sonotrode article.
